(19) United States
(12) Patent Application Publication
(10) Pub. No.: US 2025/0192502 A1
(43) Pub. Date: Jun. 12, 2025

(54) ARRANGEMENT COMPRISING A SEPARATING DEVICE, A CONDUCTOR PROCESSING STATION AND A TRANSPORT DEVICE

(71) Applicant: SW Automatisierung GMBH, Golling an der Salzach (AT)

(72) Inventors: Johannes SCHAUER, Kuchl (AT); Rupert Lindner, Kuchl (AT); Felix Gruenwald, Bischofshofen (AT)

(21) Appl. No.: 18/975,571

(22) Filed: Dec. 10, 2024

(30) Foreign Application Priority Data
Dec. 11, 2023 (AT) A50993/2023

(51) Int. Cl. H01R 43/055

(52) U.S. Cl. CPC H01R 43/055

(57) ABSTRACT

An arrangement includes at least one separating device, preferably a vibrating feeder bowl, for conductor end pieces, at least one conductor processing station, preferably a crimping unit, and at least one transport device for transporting the conductor end pieces at least in sections between the at least one separating device and the at least one conductor processing station, preferably for feeding the at least one conductor processing station with the conductor end pieces. The at least one transport device is arranged relative to the at least one separating device and the at least one conductor processing station such that the at least one separating device and the at least one conductor processing station are laterally offset from one another in the horizontal direction in the position of use of the arrangement, preferably spaced apart from one another.

### BACKGROUND OF THE INVENTION

The invention relates to an arrangement comprising at least one separating device, preferably a vibrating feeder bowl, for conductor end pieces, at least one conductor processing station, preferably a crimping unit, and at least one transport device for at least partially transporting the conductor end pieces between the at least one separating device and the at least one conductor processing station, preferably for feeding the at least one conductor processing station with the conductor end pieces. Furthermore, the invention relates to a wire assembly machine with at least one such arrangement. Furthermore, the invention relates to a method for transporting at least one conductor end piece between at least one separating device and at least one conductor processing station via at least one transport device.

Conventionally, a crimping unit as a conductor processing machine is supplied with the conductor end pieces to be crimped via a vibrating feeder bowl as a separating device. The conductor end pieces are filled into the vibrating feeder bowl, wherein the vibrating feeder bowl is fastened within a safety cover of the crimping unit and above the crimping unit, such that individual conductor end pieces can be fed to the crimping unit via the vibrating feeder bowl through a drop channel of the vibrating feeder bowl due to gravity. If the filling level with conductor end pieces in the vibrating feeder bowl falls below a threshold value, the filling level with conductor end pieces must be increased to prevent downtime due to insufficient feeding.

A disadvantage of the state of the art is that filling the vibrating feeder bowls requires opening the safety cover, an open safety cover being accompanied by undesirable downtime. In addition, viewing the fill level is not convenient, especially for short operators of the crimping unit. In addition, filling the vibrating feeder bowls is not ergonomic, particularly due to the accessibility of the vibrating feeder bowls when there is a plurality of vibrating feeder bowls available.

### BRIEF DESCRIPTION OF THE INVENTION

It is therefore the objective technical problem of the present invention to provide an arrangement of a separating device and a conductor processing station which is improved compared to the prior art, as well as a wire assembly machine and a method for transporting conductor end pieces from the separating device to the conductor processing station, in which the disadvantages of the prior art are at least partially eliminated. The arrangement, machine, and method have a particularly high level of user-friendliness, a particularly efficient value chain and/or a particularly high level of flexibility.

According to the invention, the at least one transport device is therefore arranged relative to the at least one separating device and the at least one conductor processing station such that the at least one separating device and the at least one conductor processing station are laterally offset from one another in the horizontal direction, preferably spaced apart from one another, in the position of use of the arrangement.

This makes it possible for the fill level or the filling with conductor end pieces of the at least one separating device to be easily identified and increased by a small number of personnel, since the lateral offset ensures that the at least one separating device can be positioned with a reduction in height of the at least one separating device—without the need for detection means for monitoring the fill level or additional components to be automated for feeding, or a reduction in construction heights, or embedding components, or separate support means for the personnel. In addition, the risk is reduced that an insufficient fill level of at least one separating device is overlooked or that filling occurs too late, which would result in downtime.

Furthermore, it can be ensured that even with a high number of separating devices, a supply of conductor end pieces can be created to provide a favorable accessibility situation for personnel. An outer contour of the conductor processing station, preferably a lateral boundary surface of the crimping unit (if applicable, the crimping device) facing the separating device and/or adjacent to the separating device, and an outer contour of the separating device, preferably a jacket surface of the vibrating feeder bowl facing the conductor processing station and/or adjacent to the conductor processing station, can serve as a reference for the lateral offset.

Preferably, a mounting plate for the at least one separating device is spatially separated in the lateral direction from a mounting plate for the at least one conductor processing station. Particularly preferably, the at least one separating device, preferably starting from a loading opening for conductor end pieces or an upper edge of the at least one separating device, is also positioned at a varying distance from a floor in the vertical direction relative to the at least one conductor processing station, preferably a horizontally oriented axis of symmetry of an arrangement of crimping jaws of the crimping unit in the crimping position, in addition to the lateral spacing from the at least one conductor processing station. The at least one separating device can, for example, be located closer to or farther away from the floor on which the wire assembly machine rests than the at least one conductor processing station.

In addition, there is the positive property that the location of the at least one separating device can be adjusted flexibly—substantially regardless of a necessary fall height for the conductor end pieces and/or the location of the at least one conductor processing station. For example, a closed safety cover can remain closed for the at least one conductor processing station and a refilling process with regard to the conductor end pieces can be carried out during the production process—without having to interrupt production or the refilling process being at the expense of the safety of the personnel. By separating the at least one separating device and the at least one conductor processing station, the refilling process can be carried out externally or remotely with respect to the conductor processing station, wherein the at least one separating device can be arranged or relocated, for example, depending on constraints such as the conditions in the room.

In addition, a space now freely available above the at least one conductor processing station can be used, for example, as storage space for purposes other than positioning the at least one separating device, or the overall height of a wire assembly machine can be reduced with such an arrangement. In addition, transport or assembly can be facilitated by decoupling the at least one conductor processing station from the at least one separating device.

In addition, due to the (spatial and/or functional) separation between feeding and processing, it is possible that in the case of a relative movement of, for example, a crimping unit as a conductor processing station and the components required for separation during feeding of the crimping unit, a mass to be moved can be reduced, since the at least one separating device does not have to be moved together with the crimping unit or any additional separating device for the crimping unit that may be present. Due to the possible flexibility in the design of the at least one transport device, it is also possible to shift movements of components according to the prior art to the at least one transport device with low weight.

As stated at the outset, protection is also sought for a wire assembly machine with at least one such arrangement.

In particular, the at least one transport device can be made available as an add-on for existing wire assembly machines as a retrofit component—without requiring an adaptation of the at least one separating device and/or a structural redesign of the at least one conductor processing station.

As stated at the outset, protection is also sought for a method for transporting at least one conductor end piece between at least one separating device and at least one conductor processing station via at least one transport device, preferably such an arrangement wherein a plurality of conductor end pieces are separated by the at least one separating device and a separate conductor end piece or a collected plurality of separated conductor end pieces is/are transported by means of at least one pneumatic device along the at least one transport device to another separating device or the at least one conductor processing station.

In the context of the invention, the technical term pneumatic device is to be interpreted as a device with which at least one conductor end piece can be moved along the transport device by means of a pressure difference and/or a fluid cushion. The preferred fluid is air, although the fluid is generally arbitrary. The pressure difference is preferably present in the form of an overpressure in the transport device upstream of the conductor end piece(s), such that the conductor end piece(s) can be moved along the transport device by means of a fluid back pressure in the form of a fluid cushion, wherein in general, alternatively or in addition, a negative pressure downstream of the conductor end piece(s) in the transport direction along the transport device can be provided for sucking in the conductor end piece(s).

Particularly preferably, the at least one pneumatic device generates an overpressure by means of air as a medium, wherein in general a negative pressure and/or other fluids for transporting conductor end pieces are possible. Preferably, the at least one pneumatic device comprises a pump for building up a pressure and/or a valve for controlling a pressure flow and/or a blower for forwarding a pressure pulse.

By using at least one pneumatic device, the at least one transport device can be designed to be particularly flexible. For example, in the case of a desired change to the relative positioning between the at least one separating device and the at least one conductor processing station, no change to the structural design of the at least one transport device and no change to the at least one pneumatic device is required.

According to an advantageous embodiment of the present invention, the at least one separating device is arranged in the use position of the arrangement in the vertical direction substantially at the same height as the at least one conductor processing station and/or outside a safety cover for the at least one conductor processing station. Preferably, in the use position of the arrangement, an axis of a conductor arranged within the at least one conductor processing station and/or a feeding opening for conductor end pieces of the at least one separating device is spaced from a floor in the range between 0.5 m and 1.5 m.

When positioned substantially at the same height, for example, a crimping process between a conductor and a conductor end piece can be monitored at the same viewing angle while the supply of the at least one separating device can be monitored. The vertical spacing of the axis from the ground particularly preferably corresponds to a horizontally oriented axis of symmetry of an arrangement of crimping jaws of a crimping device in the crimping position of the crimping unit.

As a reference for the distance of the at least one separating device from the ground, a feeding opening for conductor end pieces, which preferably corresponds to an upper edge of a vibrating feeder bowl, can generally be used.

Advantageously, in the present invention, the at least one transport device is designed:
at least partially in the form of at least one flexible, preferably plastic-like, hose and/or
is curved, preferably in a spline shape and/or in an S-shape, and/or
has a longitudinal extension in the range between 1 m and 5 m, preferably between 2 m and 3.5 m.

For example, if the at least one transport device is in the form of a flexible hose, the hose can be bent into the desired shape depending on the relative positioning between the at least one separating device and the at least one conductor processing station, wherein in general rigid and/or metallic transport devices can also be provided. Repositioning a transport device made of plastic can be achieved particularly easily.

If the at least one transport device is in an S-shape, gravity can be used in the movement of the at least one conductor end piece downstream of the at least one separating device and upstream and/or downstream of a possibly present further separating device of the at least one conductor processing station.

Particularly preferably, the at least one transport device comprises at least one pneumatic device, preferably a compressed air device, for applying force to the conductor end pieces, wherein the at least one transport device can be continuously supplied with compressed air and/or with discrete pneumatic pulses by the at least one pneumatic device, wherein preferably the at least one pneumatic device is designed, particularly preferably automated, to move exactly one conductor end piece or at least 5 or 10 or 15 conductor end pieces together along the at least one transport device, and/or the at least one transport device comprises at least one, particularly preferably automated, collecting device, particularly preferably collecting slider, for conductor end pieces.

The at least one pneumatic device has proven to be a particularly advantageous means of applying force to conductor end pieces in internal tests, which can ensure rapid transport of the conductor end pieces with little expenditure of resources and which is substantially independent of the geometry of the at least one transport device. If a plurality of conductor end pieces are transported together, compressed air can be saved, for example, although joint transport of conductor end pieces is generally not absolutely necessary.

The at least one collecting device can basically be provided by the geometry of the at least one transport device, wherein preferably a, preferably automated, collecting slider temporarily stops the transport along the at least one transport device and, when a defined number of conductor end pieces are present—for example detected by at least one control and/or regulating device via an analysis of the number of forwarding movements on the at least one separating device—releases the predefined number of conductor end pieces for further transport along the at least one transport device.

It has proven to be advantageous that the at least one transport device comprises at least one bypass channel, wherein the at least one pneumatic device is arranged on the at least one bypass channel and/or at least partially within the at least one bypass channel and/or is arranged relative to the at least one bypass channel such that compressed air can be supplied to the at least one transport device via the at least one bypass channel.

When arranged on the at least one bypass channel, the entry of the conductor end pieces into the at least one transport device is not disturbed and the introduction of compressed air pulses into the at least one transport device can be carried out particularly favorably.

According to an advantageous embodiment of the invention, the at least one transport device comprises at least one sealing device for inhibiting or preventing a pressure loss within the at least one transport device. Preferably, the at least one sealing device:
is arranged in the region of an inlet opening of the at least one transport device and/or of an optionally present bypass channel, and/or
can be activated temporarily during a transport of at least one conductor end piece along the at least one transport device, and/or
comprises a, particularly preferably automated, mechanism for at least partially sealing the at least one transport device.

By means of the at least one sealing device, a strength of a pneumatic pulse for the transfer of conductor end pieces can be reduced, wherein the risk of the conductor end pieces stopping within the at least one transport device during the transport of the conductor end pieces can be reduced.

For example, a sealing means can reduce or completely prevent the supply of air into the at least one transport device via a controlled mechanism over the duration of the pneumatic pulse.

An advantageous variant of the present invention consists in that at least one control and/or regulating device is provided which is configured to pivot the at least one conductor processing station, preferably depending on a transfer of a conductor end piece into the at least one conductor processing station, and/or to move it relative to the at least one transport device, preferably translationally, and/or
a pneumatic pulse with a duration in the range between 1 s and 2.5 s, and/or
a plurality of pneumatic pulses with a time difference in the range between 1 s and 2.5 s, and/or
a pneumatic pulse depending on an entry of a conductor end piece into the at least one transport device and/or a presence of a predefined number of conductor end pieces, preferably exactly one conductor end piece or at least 5 or 10 or 15 conductor end pieces, within the at least one transport device via the at least one pneumatic device to the at least one transport device.

The at least one control and/or regulating device can generally be programmed to control all or at least some of the automated components.

Preferably, the at least one separating device is designed in the form of at least one vibrating feeder bowl, wherein the at least one vibrating feeder bowl comprises at least one displacement device, preferably a pivoting device, for the preferably automated removal of the conductor end pieces from the at least one vibrating feeder bowl and/or for feeding the conductor end pieces into the at least one transport device, preferably via at least one drop channel of the at least one vibrating feeder bowl.

In general, the at least one displacement device can transport a conductor end piece away from the separating device by translational movement. However, removal by means of pivoting movements of a displacement device in the form of a pivoting device is preferred.

Particularly preferably, a plurality of vibrating feeder bowls is provided. Preferably, at least 10 vibrating feeder bowls are used, wherein particularly preferably exactly 16 vibrating feeder bowls—preferably arranged in a grid or substantially ring-shaped manner—are provided as separating devices for the at least one conductor processing station.

In one embodiment of the invention, the at least one displacement device comprises at least one, preferably optical, sensing means with which the presence of a conductor end piece at the at least one displacement device can be detected, and/or comprises at least one cycle counter for pivoting movements of the at least one displacement device relative to the at least one vibrating feeder bowl.

The sensing means can determine that a conductor end piece is positioned such that it can be fed into a transport device, wherein the feeding into the transport device can be detected to control the pneumatic device and/or to monitor the number of conductor end pieces that have entered the transport device for a common transport. The sensing device can generally be in mechanical form, although an optical sensor is preferred.

According to a preferred embodiment of the invention, the at least one pneumatic device and/or the at least one bypass channel is arranged in the position of use of the arrangement in the vertical direction below the at least one drop channel, preferably in the region of an inlet opening of the at least one drop channel.

This allows, for example, the pneumatic device to be arranged in a position on the arrangement that is easy to maintain or convenient for the introduction of a pneumatic pulse and/or a pre-positioning of the conductor end piece for further transport can be achieved by gravity.

Furthermore, particularly preferably the at least one conductor processing station is in the form of at least one crimping unit, wherein the at least one crimping unit comprises at least one crimping device and/or at least one further separating device.

By means of the at least one further separating device, the feeding of the at least one crimping device can be handled independently of a feeding of the at least one separating device and/or a transport along the at least one transport device.

If at least two crimping devices are provided, for example, a conductor loop with two free ends can be crimped on both sides, whereby the cycle time can be reduced.

It has proven to be advantageous that at least one further separating device is provided, wherein the at least one further separating device is in the form of at least one magazine and the at least one magazine comprises a plurality of storage spaces for varying conductor end pieces and/or at least one slider for the, preferably automated, separate further transport of the conductor end pieces to the at least one optionally present crimping device, particularly preferably via a further drop channel. Preferably:
the at least one optionally present crimping device is designed to be pivotable between a feeding position and a crimping position, particularly preferably substantially by 90 degrees, and/or
the at least one transport device is movable relative to the at least one magazine such that the conductor end pieces can be selectively transported into one of the plurality of storage spaces, and/or
the conductor end pieces can be forwarded by the at least one separating device to the at least one transport device and/or by the at least one further separating device to the at least one optionally present crimping device, and/or by the at least one transport device to the at least one conductor processing station in cycle times that vary from one another.

If the at least one crimping device is pivotable, entry into the at least one crimping device can be due to gravity and the conductor for a crimp connection can be fed by a translationally movable shuttle of the wire assembly machine. If a relative displacement between the at least one transport device and the at least one magazine is possible, pre-sorting can be carried out depending on the type or size of the conductor end piece. If the arrangement can be operated in different cycle times, the separation process on the at least one separating device can take place independently of the transport process or the feeding of the at least one crimping device or the cycle time of the at least one crimping device, or the transport process can take place independently of feeding or the cycle time.

Furthermore, the wire assembly machine is preferably fed with a plurality of conductor end pieces arranged within the at least one separating device, preferably with wire end ferrules, turned contacts, cable lugs, flat plug sleeves, and/or crimp connections.

In a preferred embodiment of the invention:
the conductor end pieces can be forwarded by the at least one separating device to the at least one transport device and/or by the at least one further separating device to the at least one optionally present crimping device, and/or by the at least one transport device to the at least one conductor processing station in cycle times, and/or
at least one crimping device of the at least one conductor processing station is pivoted and/or the at least one transport device is moved relative to the at least one further separating device.

According to an advantageous embodiment of the invention,
a sensing means detects the presence of a conductor end piece at the at least one separating device, and/or
at least one control and/or regulating device determines a number of conductor end pieces introduced into the at least one transport device, and/or
the at least one transport device is sealed at least temporarily during transport along the at least one transport device.

### BRIEF DESCRIPTION OF THE DRAWINGS

Further details and advantages of the present invention are explained in more detail below based on the description with reference to the drawings, in which:

FIGS. 1a, 1b are perspective views in varying viewing directions of an arrangement according to a particularly preferred exemplary embodiment,

FIGS. 2a, 2b are perspective views in varying viewing directions of an arrangement according to another particularly preferred exemplary embodiment, and

FIGS. 3a-3g show the arrangement according to the embodiment according to FIGS. 2a and 2b in different operating positions during separation process steps or the transport along a transport device between a vibrating feeder bowl and a crimping device, each in a plan view and a sectional view, in a side view, and a perspective view.

### DETAILED DESCRIPTION OF THE INVENTION

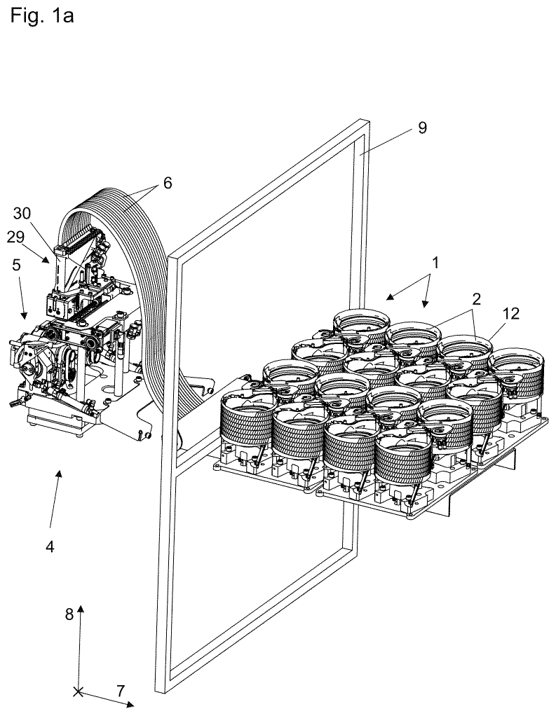

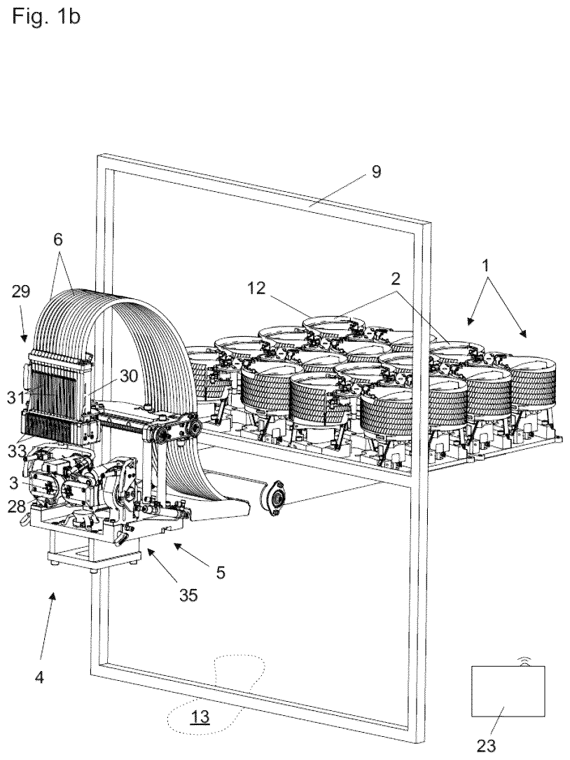

FIG. 1a shows an arrangement of a plurality of separating devices 1 for conductor end pieces 3 in the form of vibrating feeder bowls 2, a conductor processing station 4 in the form of a crimping unit 5, and a plurality of transport devices 6 for transporting the conductor end pieces 3 between the separating devices 1 and the conductor processing station 4 for feeding the conductor processing station 4 with the conductor end pieces 3. One transport device 6 is provided for each separating device 1, although this is generally not absolutely necessary.

The number of separating devices 1 and transport devices 6 is generally arbitrary.

The transport devices 6 are arranged and connected relative to the separating devices 1 and the conductor processing station 4 in such a way that the separating devices 1 and the conductor processing station 4, in the illustrated position of use of the arrangement, are laterally offset from one another in the horizontal direction 7 and are arranged spatially spaced from one another in the horizontal direction 7.

In the position of use of the arrangement, the separating devices 1 are arranged in the vertical direction 8 at the same height as the conductor processing station 4 and outside a safety cover 9 for the conductor processing station 4.

FIG. 1b shows the arrangement as part of a wire assembly machine, wherein the wire assembly machine can have a stripping unit as a conductor processing station and a handling system for transporting the conductor between the conductor processing stations, such as a movable shuttle.

During operation of the wire assembly machine, conductor end pieces 3 are generally arranged in at least one of the separating devices 1 in order to ensure continuous feeding of the crimping unit 5. The conductor end pieces can be in the form of wire end ferrules, turned contacts, cable lugs, flat plug sleeves, crimp connections, etc.

In the position of use of the arrangement, the feeding openings 12 for conductor end pieces 3 of the separating devices 1 are spaced between 0.8 m and 1.3 m from a floor 13.

The crimping unit 5 comprises two crimping devices 28 and a further separating device 29.

The further separating device 29 is in the form of a magazine 30, wherein the magazine 30 has a plurality of storage spaces 31 for varying conductor end pieces 3 and (not shown for reasons of clarity) sliders for automated, individual transport of the conductor end pieces 3 to the crimping devices 28. The sliders can, for example, be such that a conductor end piece 3 is moved relative to the associated storage space 31 or is released relative to the associated storage space 31 to drop into the crimping device 28.

In general, the transport device 6 is movable relative to the magazine 30, such that the conductor end pieces 3 of the separating device 1 can be selectively transported into one of the plurality of storage spaces 31, wherein, in the illustrated exemplary embodiment, one storage space 31 is associated with each separating device 1 and different conductor end pieces 3 of the crimping devices 28 can be fed by relative movement of the magazine 30 relative to the crimping devices 28 or vice versa. In this respect, however, no movement of the separating devices 1 relative to the crimping device 28 or the magazine 30 is required, so that less mass has to be moved for this purpose.

At the bottom right of the illustration, a schematic view of a control and/or regulating device 23 for automating the separation, transport, and/or crimping process is provided, which device can be in radio signal-transmitting and/or wired connection with the arrangement. The control and/or regulating device 23 can, for example, be integrated in a machine controller or be provided as a unit separate from the machine controller in order to control at least a proper transport of the conductor end pieces 3 from the separating devices 1 to the further separating device 29 or the crimping devices 28.

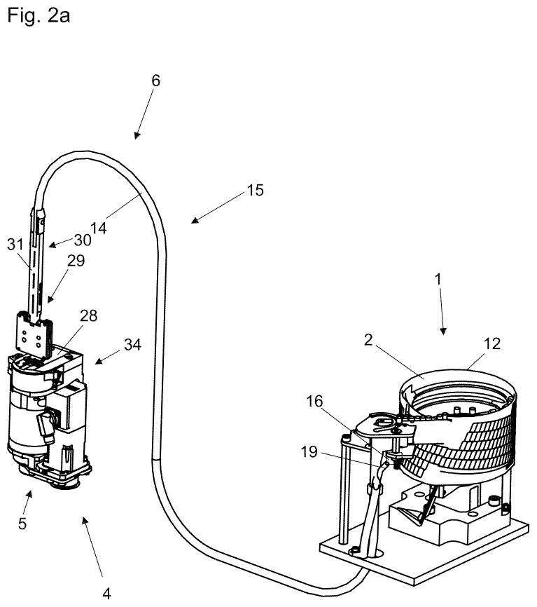

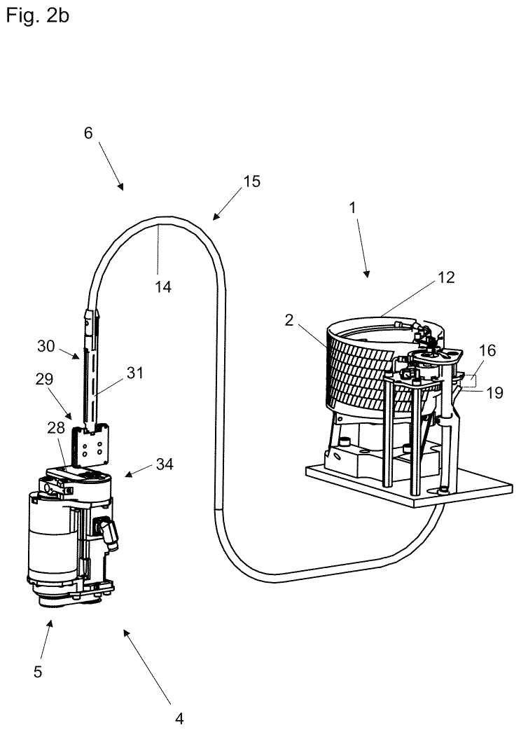

FIG. 2a shows an arrangement with a vibrating feeder bowl 2, a transport device 6 and a crimping device 28, which can, for example, represent part of the arrangement according to FIG. 1a and FIG. 1b.

The transport device 6 comprises a pneumatic device 16—indicated schematically in dashed lines—in the form of a compressed air device for applying force to the conductor end pieces 3, wherein the transport device 6 can be continuously supplied with compressed air or with discrete pneumatic pulses by the pneumatic device 16.

The pneumatic device 16 is designed to move—for example automatically in interaction with the control and/or regulating device 23—at least 15 conductor end pieces 3 together along the transport device 6, wherein the number of conductor end pieces 3 transported together is generally arbitrary and a transport of individual conductor end pieces 3 can be provided.

The transport device 6 comprises a collecting device for conductor end pieces 3, which is due to the curvature of the transport device 6. In general, however, an automated collecting slider can be used, for example, which holds conductor end pieces 3 in the transport device 6 and releases the conductor end pieces 3 for further transport when a predefined number of conductor end pieces 3 (or a predefined time for the transport of the conductor end piece 3) is present.

The number of pneumatic devices 16 is generally arbitrary, wherein a common pneumatic device 16 can be used for a plurality of separating devices 1, for example. Preferably, one pneumatic device 16 is used per separating device 1.

The transport device 6 comprises a bypass channel 19, wherein the pneumatic device 16 is arranged on the bypass channel 19 and is connected relative to the bypass channel 19 such that compressed air for the transport of the conductor end pieces 3 can be supplied to the transport device 6 via the bypass channel 19.

FIG. 2b differs from FIG. 2a only in that it is viewed from a different angle.

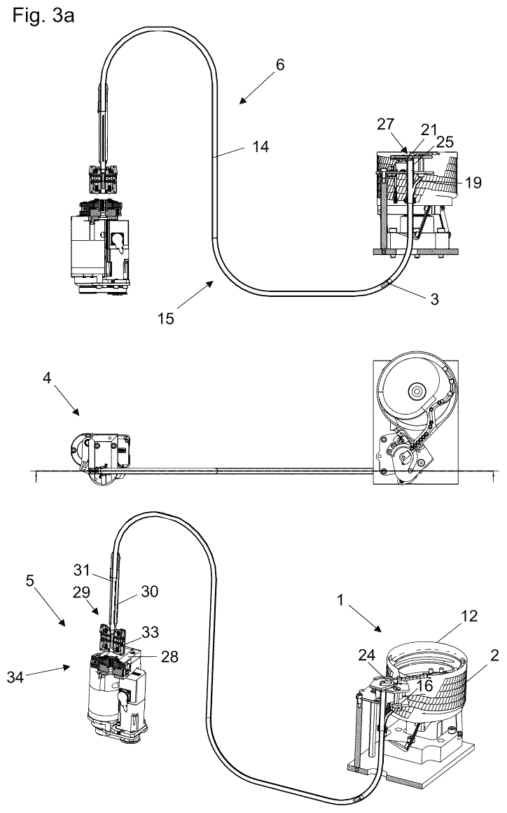

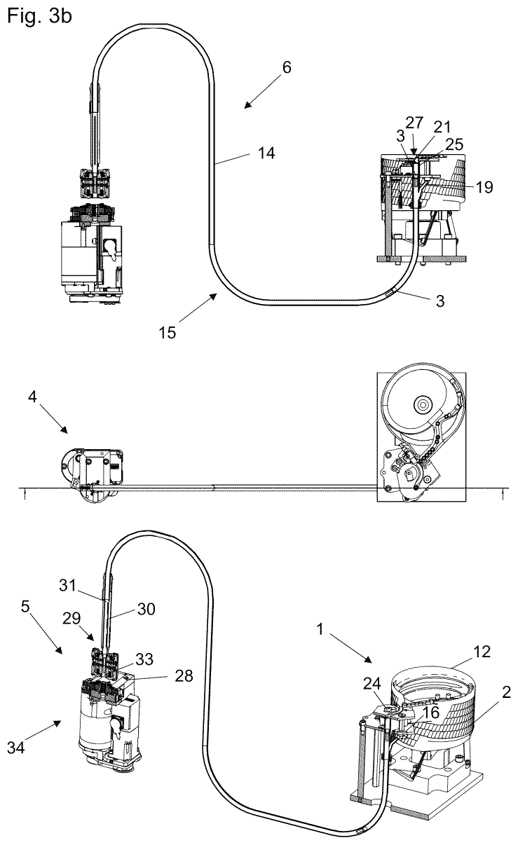

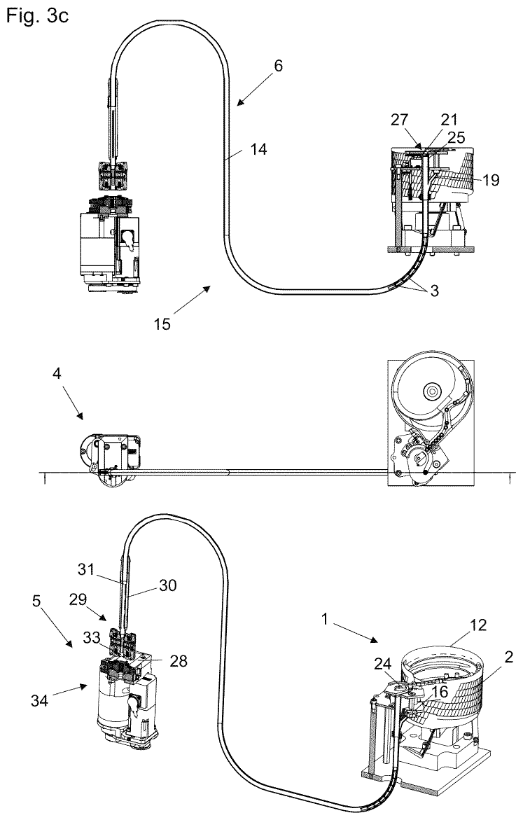

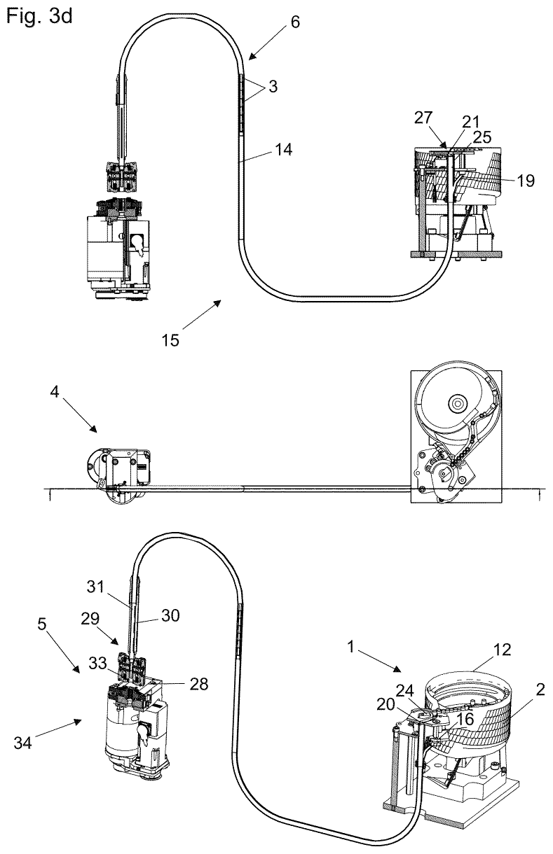

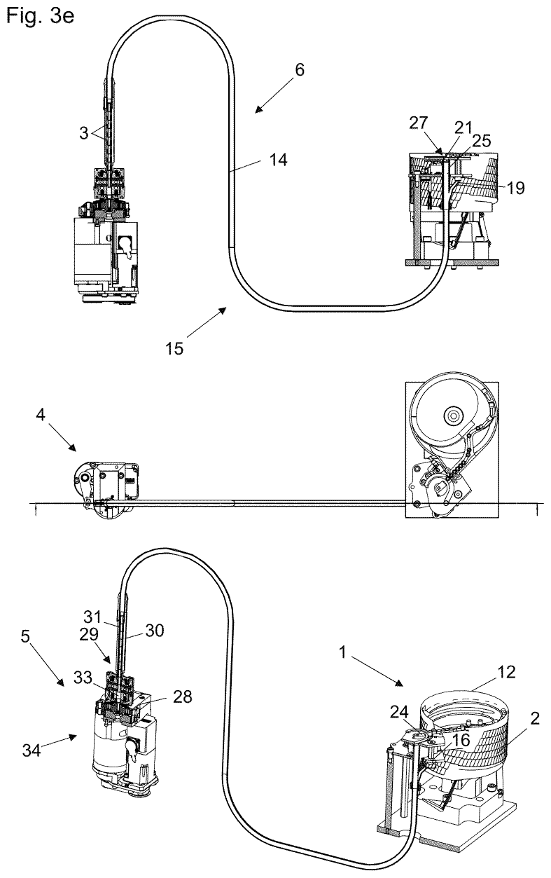

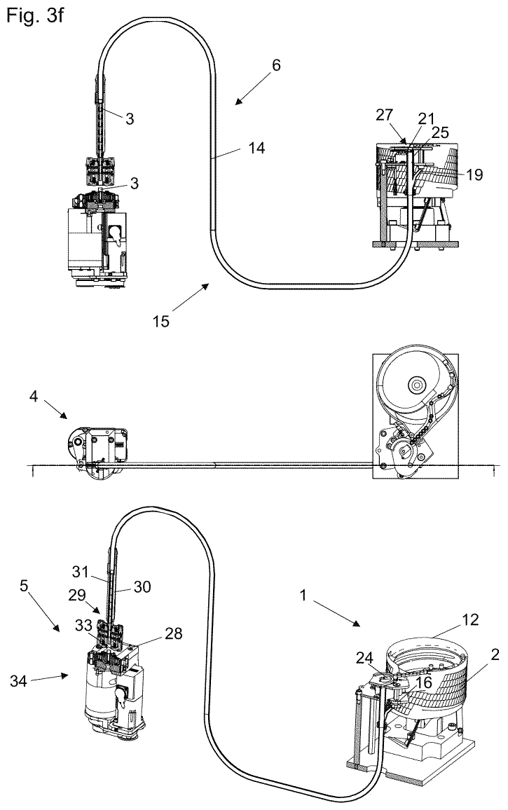

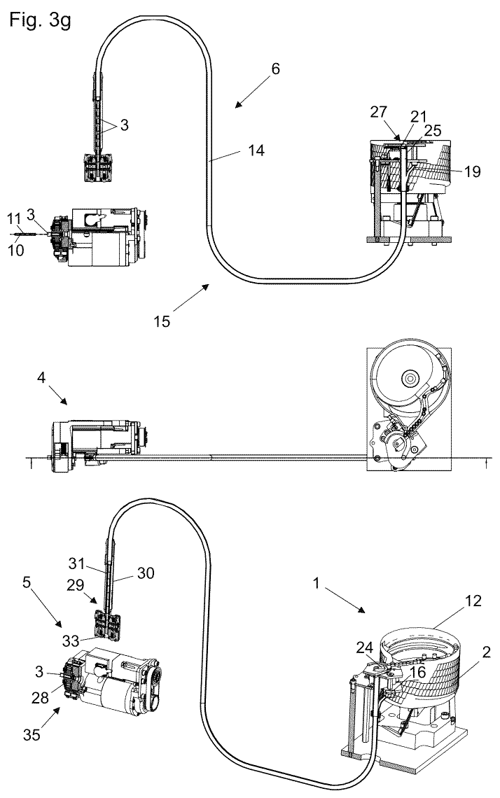

FIG. 3a to FIG. 3g visualize the movement of the conductor end pieces 3 from the separating devices 1 to a crimping process on the crimping device 28 along the arrangement shown by sectional views.

An exemplary method for transporting conductor end pieces 3 between the separating device 1 and the conductor processing station 4 via the transport device 6 of the arrangement can be explained as follows: A plurality of conductor end pieces 3 are separated by the separating device 1, wherein a sensing means detects the presence of a conductor end piece 3 on the separating device 1 and forwards one conductor end piece 3 at a time to the transport device 6. The control and/or regulating device 23 determines a number of conductor end pieces 3 introduced into the transport device 6, wherein, if a predefined number of conductor end pieces 3 is present, the collected plurality of separated conductor end pieces 3 is transported by means of the pneumatic device 16 along the transport device 6 to the further separating device 29 of the conductor processing station 4 comprising at least one crimping device 28, wherein the transport device 6 is at least partially sealed (temporally and/or spatially) during transport to increase efficiency. By means of the further separating device 29, the crimping device 28 (preferably two crimping devices 28 and optionally by movement between the further separating device 29 and the crimping device 28) is fed with a conductor end piece 3. Subsequently, the crimping device 28 is pivoted, a conductor 11 is inserted into the conductor end piece 3, and the crimping process is started.

The process can be carried out analogously if only one conductor end piece 3 enters the transport device 6, wherein the collection process for the conductor end pieces 3 is omitted and a pneumatic pulse with a lower strength is sufficient for transport through the transport device 6.

The cycle times of the separation at the separating device 1, the transport via the transport device 6, and the separation at the further separating device 29 can be selected independently of one another.

FIG. 3a shows the process of separation at the separating device 1, wherein the separating device 1 is designed in the form of the vibrating feeder bowl 2 and the vibrating feeder bowl 2 comprises a pivoting device 24 for the automated removal of the conductor end pieces 3 from the vibrating feeder bowl 2 for feeding the conductor end pieces 3 into the transport device 6.

The vibrating feeder bowl 2 comprises an optical sensing means for the pivoting device 24, with which the presence of a conductor end piece 3 on the pivoting device 24 can be detected.

The pivoting movements or rotational movements of the pivoting device 24 are used via the control and/or regulating device 23 as a clock for determining the number of conductor end pieces 3 fed to the transport device 6, such that the vibrating feeder bowl 2 comprises a clock counter for pivoting movements of the pivoting device 24 relative to the vibrating feeder bowl 2. In general, however, other transfer mechanisms for forwarding the conductor end pieces 3 to the transport device 6 are also possible.

FIG. 3b shows that the conductor end piece 3 is fed to the transport device 6 via a drop channel 25 of the vibrating feeder bowl 2, wherein the drop channel 25 can already be associated with the transport device 6.

The connections of the pneumatic device 16 to the transport device 6 and the bypass channel 19 are arranged in the position of use of the arrangement in the vertical direction 8 below the drop channel 25 in the region of an inlet opening 27 of the drop channel 25 of the transport device 6.

The transport device 6 is designed in some areas in the form of a flexible and plastic-like hose 14, wherein the bypass channel 19 and the drop channel 25 can be metallic or likewise flexible and plastic-like.

The hose 14 is bent in an S-shape 15 and has a longitudinal extension between 2 m and 3.5 m.

FIG. 3c shows that conductor end pieces 3 are successively collected in the transport device 6 before further transport to the further separating device 29 is generated. The number of conductor end pieces 3 to be collected can be selected individually depending on the requirements of the arrangement.

FIG. 3d shows the point in time during a transport of a plurality of conductor end pieces 3 along the transport device 6.

In the perspective sectional view at the bottom right, it is schematically indicated in dashed lines that the transport device 6 in the region of the drop channel 25 comprises a sealing device 20 for inhibiting or preventing a loss of pressure within the transport device 6 during the transport of the conductor end pieces 3.

The sealing device 20 is not absolutely necessary, but it can support the transport of the conductor end pieces 3. Preferably, the sealing device 20 is arranged in the region of an inlet opening 21 of the transport device 6 or the bypass channel 19, is temporarily active during the transport of the conductor end piece 3 along the transport device 6, and is activated by means of an automated mechanism for sealing the transport device 6.

For the transport of the conductor end pieces 3, the control and/or regulating device 23 is configured to forward a pneumatic pulse depending on the entry of a conductor end piece 3 into the transport device 6 or the presence of a predefined number of conductor end pieces 3 within the transport device 6
via the pneumatic device 16 to the transport device 6. As for the pneumatic pulses, a duration between 1 s and 2.5 s or (in particular when transporting individual conductor end pieces 3) a time difference between 1 s and 2.5 s can be provided, wherein the parameters can be flexibly adjusted depending on the requirements of the arrangement.

FIG. 3e shows the operating position of the arrangement in which the conductor end pieces 3 have already been forwarded by the transport device 6 to the further separating device 29 to be fed to the crimping device 28 or the crimping devices 28.

FIG. 3f shows the crimping device 28 in a feeding position 34, in which the conductor end pieces 3—separated by the further separating device 29 due to gravity—can be fed to the crimping device 28, wherein a conductor end piece 3 has already been arranged in the crimping device 28 via a further drop channel 33 of the further separating device 29.

The control and/or regulating device 23 is configured to move the conductor processing station 4 translationally relative to the transport device 6 and to pivot it depending on a transfer of the conductor end piece 3 into the conductor processing station 4.

FIG. 3g shows the arrangement after a pivoting operation of the crimping device 28, wherein the crimping device 28 was transferred from the feeding position 34 into the crimping position 35, a change by 90 degrees.

In the sectional view located at the top, a conductor 11 is schematically indicated for feeding into the conductor end piece 3, wherein preferably two free ends of the conductor 11 are simultaneously introduced into two conductor end pieces 3 present in two crimping devices 28.

In the position of use of the arrangement, an axis 10 of the conductor 11 subsequently arranged within the conductor processing station 4 and the feeding opening 12 for conductor end pieces 3 of the separating device 1 are spaced between 0.5 m and 1.5 m from the floor 13.

1. An arrangement comprising at least one separating device, preferably a vibrating feeder bowl, for conductor end pieces, at least one conductor processing station, preferably a crimping unit, and at least one transport device for transporting the conductor end pieces at least in sections between the at least one separating device and the at least one conductor processing station, preferably for feeding the at least one conductor processing station with the conductor end pieces, wherein the at least one transport device is arranged relative to the at least one separating device and the at least one conductor processing station such that the at least one separating device and the at least one conductor processing station are laterally offset from one another in the horizontal direction in the position of use of the arrangement, preferably spaced apart from one another.

2. The arrangement according to claim 1, wherein the at least one separating device is arranged in the use position of the arrangement in the vertical direction substantially at the same height as the at least one conductor processing station and/or outside a safety cover for the at least one conductor processing station, wherein it is preferably provided that in the use position of the arrangement, an axis of a conductor arranged within the at least one conductor processing station and/or a feeding opening for conductor end pieces of the at least one separating device is spaced from a ground in the range between 0.5 m and 1.5 m.

3. The arrangement according to claim 1, wherein the at least one transport device:
is at least in sections present in the form of at least one flexible, preferably plastic-like, hose (14), and/or
is curved, preferably in a spline shape and/or in an S-shape (15), and/or
has a longitudinal extension in the range between 1 m and 5 m, preferably between 2 m and 3.5 m.

4. The arrangement according to claim 1, wherein the at least one transport device comprises at least one pneumatic device, preferably a compressed air device, for applying force to the conductor end pieces, wherein the at least one transport device can be continuously supplied with compressed air and/or with discrete pneumatic pulses by the at least one pneumatic device, wherein it is preferably provided that the at least one pneumatic device is designed, particularly preferably automated, to move exactly one conductor end piece or at least 5 or 10 or 15 conductor end pieces together along the at least one transport device, and/or the at least one transport device comprises at least one, particularly preferably automated, collecting device, particularly preferably collecting slider, for conductor end pieces.

5. The arrangement according to claim 4, wherein the at least one transport device comprises at least one bypass channel, wherein the at least one pneumatic device is arranged on the at least one bypass channel and/or at least in sections within the at least one bypass channel and/or is arranged relative to the at least one bypass channel such that compressed air can be supplied to the at least one transport device via the at least one bypass channel.

6. The arrangement according to claim 1, wherein the at least one transport device comprises at least one sealing device for inhibiting or preventing a pressure loss within the at least one transport device, wherein preferably the at least one sealing device:
is arranged in the region of an inlet opening of the at least one transport device and/or of an optionally present bypass channel, and/or
can be activated temporarily during a transport of at least one conductor end piece along the at least one transport device, and/or
comprises a, particularly preferably automated, mechanism for at least partially sealing the at least one transport device.

7. The arrangement according to claim 4, wherein at least one control and/or regulating device is provided, which is configured to pivot the at least one conductor processing station, preferably depending on a transfer of a conductor end piece into the at least one conductor processing station, and/or to move it relative to the at least one transport device, preferably translationally, and/or to forward:
a pneumatic pulse with a duration in the range between 1 s and 2.5 s, and/or
a plurality of pneumatic pulses with a time difference in the range between 1 s and 2.5 s, and/or
a pneumatic pulse depending on an entry of a conductor end piece into the at least one transport device and/or a presence of a predefined number of conductor end pieces, preferably exactly one conductor end piece or at least 5 or 10 or 15 conductor end pieces, within the at least one transport device
via the at least one pneumatic device to the at least one transport device.

8. The arrangement according to claim 1, wherein the at least one separating device is designed in the form of at least one vibrating feeder bowl, wherein the at least one vibrating feeder bowl comprises at least one displacement device, preferably a pivoting device, for the preferably automated removal of the conductor end pieces from the at least one vibrating feeder bowl and/or for feeding the conductor end pieces into the at least one transport device, preferably via at least one drop channel of the at least one vibrating feeder bowl.

9. The arrangement according to claim 8, wherein the at least one displacement device comprises at least one, preferably optical, sensing means with which the presence of a conductor end piece at the at least one displacement device can be detected, and/or comprises at least one cycle counter for pivoting movements of the at least one displacement device relative to the at least one vibrating feeder bowl.

10. The arrangement according to claim 5, wherein the at least one pneumatic device and/or the at least one bypass channel is arranged in the position of use of the arrangement in the vertical direction below the at least one drop channel, preferably in the region of an inlet opening of the at least one drop channel.

11. The arrangement according to claim 1, wherein the at least one conductor processing station is present in the form of at least one crimping unit, wherein the at least one crimping unit comprises at least one crimping device and/or at least one further separating device.

12. The arrangement according to claim 1, wherein at least one further separating device is provided, wherein the at least one further separating device is present in the form of at least one magazine and the at least one magazine comprises a plurality of storage spaces for varying conductor end pieces and/or at least one slider for the, preferably automated, separate further transport of the conductor end pieces to the at least one optionally present crimping device, particularly preferably via a further drop channel, wherein preferably:
the at least one optionally present crimping device is designed to be pivotable between a feeding position and a crimping position, particularly preferably substantially by 90 degrees, and/or
the at least one transport device is movable relative to the at least one magazine such that the conductor end pieces can be selectively transported into one of the plurality of storage spaces, and/or
the conductor end pieces can be forwarded by the at least one separating device to the at least one transport device and/or by the at least one further separating device to the at least one optionally present crimping device, and/or by the at least one transport device to the at least one conductor processing station in cycle times that vary from one another.

13. A wire assembly machine having at least one arrangement according to claim 1.

14. The wire assembly machine according to claim 13 with a plurality of conductor end pieces arranged within the at least one separating device, preferably wire end ferrule, turned contact, cable lug, flat plug sleeve, and/or crimp connection.

15. A method for transporting at least one conductor end piece between at least one separating device and at least one conductor processing station via at least one transport device, preferably an arrangement according to claim 1, wherein a plurality of conductor end pieces are separated by the at least one separating device and a separate conductor end piece or a collected plurality of separated conductor end pieces is/are transported by means of at least one pneumatic device along the at least one transport device to a further separating device or the at least one conductor processing station.

16. The method according to claim 15, wherein:
the conductor end pieces can be forwarded by the at least one separating device to the at least one transport device and/or by the at least one further separating device to the at least one crimping device, and/or by the at least one transport device to the at least one conductor processing station in different cycle times, and/or
at least one crimping device of the at least one conductor processing station is pivoted and/or the at least one transport device is moved relative to the at least one further separating device.

17. The method according to claim 15, wherein:
a sensing means detects the presence of a conductor end piece at the at least one separating device, and/or
at least one control and/or regulating device determines a number of conductor end pieces introduced into the at least one transport device, and/or
the at least one transport device is sealed at least temporarily during transport along the at least one transport device.
